(19) United States
(12) Patent Application Publication
(10) Pub. No.: US 2025/0115471 A1
(43) Pub. Date: Apr. 10, 2025

(54) SEAT SKIN ATTACHMENT DEVICE

(71) Applicant: DELTA KOGYO CO., LTD., Hiroshima (JP)

(72) Inventors: Tatsushi TAMURA, Hiroshima (JP); Katsumi KUMAGAI, Hiroshima (JP); Tatsunori HONDA, Hiroshima (JP); Seita UEDA, Hiroshima (JP)

(73) Assignee: DELTA KOGYO CO., LTD., Hiroshima (JP)

(21) Appl. No.: 18/726,036

(22) PCT Filed: Jan. 20, 2023
(86) PCT No.: PCT/JP2023/001717

§ 371 Date: Jul. 1, 2024

(30) Foreign Application Priority Data
Jan. 28, 2022 (JP) 2022-012118

(51) Int. Cl. B68G 7/05; B60N 2/58

(52) U.S. Cl. CPC B68G 7/05; B60N 2/5891

(57) ABSTRACT

It is an object to provide a seat cover attaching device for preventing a cover from returning in pulling and attaching the cover. An attaching device includes: a compressing mechanism that compresses a pad of a seat placed in an upside-down state on a support part from a rear surface that is opposite to a sitting surface; and a pressing mechanism that presses a cover onto a surface of the pad. The pressing mechanism has a leading roller that rolls over an outer surface of the cover while pressing the cover onto the pad to thereby pull the cover and a following roller that follows the leading roller at a distance behind the leading roller. The leading roller and the following roller move from the sitting surface to a side surface of the pad via a ridge portion defined by the sitting surface and the side surface.

### TECHNICAL FIELD The present invention relates to a seat cover attaching device.

### BACKGROUND ART

Various devices have been conventionally proposed to attach a cover to a pad while pulling the cover without making a crease on a surface of the pad in manufacturing a seat to include the pad having the surface over which the cover is tensioned.

Patent Literature 1 describes a device that includes rollers located at front, rear, left, and right positions one by one to face front, rear left, and right peripheral surfaces of a pad respectively, each roller being configured to move upward while pressing a cover onto a surface of the pad to thereby pull the cover.

Specifically, the device described in Patent Literature 1 includes: a base member that supports a seat including a pad, a cover, and a seat pan (back plate) to be placed thereon in a state where a sitting surface of the pad faces downward and the cover, the pad, and the seat pan are stacked from below in this order; a compressing mechanism that pushes the pad and the seat pan downward and toward the base member; and a roller mechanism having a roller that presses the cover into close contact with a side portion of the pad being compressed by the compressing mechanism. Here, four roller mechanisms are arranged respectively at front, rear, left, and right positions of the base member, and each roller mechanism has one roller.

Each roller mechanism includes: a fluid pressure cylinder for gradually moving the roller from a lower portion to an upper portion of the pad while making the roller press the cover covering a peripheral surface of the pad into close contact with the pad; and a driving device that rotates the roller in a direction of pulling the cover upward. The compressing mechanism stops the compressing after the roller mechanism finishes the pressing of the cover. The pad is then restored to its original state, and accordingly, an upper edge of a side portion of the cover is engaged with a periphery of the seat pan.

In pulling and attaching the cover along the surface of the pad by using such a device, the device may cause, a crease in a ridge portion defined by the sitting surface and a side surface of the pad. To avoid the situation, a possible configuration may include, for example, a roller that moves from a sitting surface to a side surface via a ridge portion to stretch or tension a cover without making a crease in the ridge portion. Unfortunately, in this configuration, a pressing force of the roller to a part of the cover covering the sitting surface ceases as the roller moves from the sitting surface to the side surface via the ridge portion. The configuration thus has a drawback of cover returning that the cover shrinks and returns to its original state due to the lack of pressing force.

### CITATION LIST

### Patent Literature

Patent Literature 1: Japanese Utility Model Publication No. HEI 04-34800

### SUMMARY OF THE INVENTION

The present invention has been achieved in view of the circumstances described above, and has an object of providing a seat cover attaching device for preventing a cover from returning in pulling and attaching the cover.

A seat cover attaching device in the present invention to solve the drawback described above is a seat cover attaching device for attaching a cover covering a surface of a pad included in a seat while pulling the cover along a sitting surface of the pad and a side surface continuing to a periphery of the sitting surface. The seat cover attaching device includes: a support part that supports the pad and the cover to be placed thereon in a state where the sitting surface of the pad faces downward and the cover lies below the pad; a compressing mechanism that compresses the pad on the support part downward from a rear surface of the pad that is opposite to the sitting surface; and a pressing mechanism that presses the cover onto the surface of the pad. The pressing mechanism has a plurality of rollers that roll over an outer surface of the cover while pressing the cover onto the pad to thereby pull the cover. The rollers include a leading roller and a following roller that follows the leading roller at a distance behind the leading roller in a moving direction of the leading roller. The leading roller and the following roller move from the sitting surface to the side surface of the pad via a ridge portion defined by the sitting surface and the side surface.

### BRIEF DESCRIPTION OF DRAWINGS

FIG. 1 is a perspective view of an overall configuration of a seat cover attaching device according to an embodiment of the present invention.

FIG. 2 is a right side view of the seat cover attaching device in FIG. 1.

FIG. 3 is a perspective view of the seat cover attaching device in FIG. 1 seen from an upper front in a state where a seat including a cover and a pad is set on the device.

FIG. 4A is an enlarged plan view of a support part and pressing mechanisms in FIG. 1.

FIG. 4B is an enlarged view of the support part.

FIG. 4C is a cross-sectional view taken along the line A-A in FIG. 4B.

FIG. 5 is a schematic plan view of an arrangement of the pressing mechanisms in FIG. 1.

FIG. 6 is a schematic plan view of an arrangement of compressing mechanisms in FIG. 1.

FIG. 7A is an explanatory cross-sectional view illustrating a state before a compressing tool in FIG. 1 presses the pad.

FIG. 7B is an explanatory cross-sectional view illustrating an increased upward extension amount of an end of the cover after the compressing tool in FIG. 1 pushes the pad.

FIG. 8A is an explanatory cross-sectional view illustrating a state before the compressing tool in FIG. 1 presses the pad.

FIG. 8B is an explanatory cross-sectional view illustrating an opening part having an increased width in a rear surface of the pad after the compressing tool in FIG. 1 presses the pad.

FIG. 9 is an enlarged perspective view of a detailed configuration of each pressing mechanism in FIG. 1.

FIG. 10 is an explanatory view of a modification of a frame of a carriage in FIG. 9 with a structure having a plurality of attachment holes for allowing a change in an attachment position of a following roller.

FIG. 11 is an explanatory cross-sectional view illustrating a state of a leading roller and the following roller in FIG. 9 moving from a sitting surface to a side surface of the pad via a ridge portion.

FIG. 12 is an explanatory cross-sectional view illustrating the leading roller and the following roller in FIG. 9 at their respective positions before and after movement.

FIG. 13A is an explanatory cross-sectional view illustrating the leading roller and the following roller in FIG. 9 moving along the sitting surface of the pad.

FIG. 13B is an explanatory cross-sectional view illustrating the leading roller in FIG. 9 moving along the side surface via the ridge portion of the pad and the following roller pressing the cover onto the sitting surface to prevent the cover from returning to its original state.

FIG. 14 is an explanatory cross-sectional view illustrating the leading roller in FIG. 9 moving while pressing the cover by receiving an urging force of an elastic member.

FIG. 15A is an explanatory view illustrating a cover attaching method in use of the seat cover attaching device in FIG. 1 to describe a procedure of setting the seat on an attaching device.

FIG. 15B is an explanatory cross-sectional view illustrating the seat in FIG. 15A in which the sitting surface of the pad faces downward and the cover to be pulled lies below the pad.

FIGS. 16A to 16C are schematic explanatory views of steps in the procedure of setting the seat on the attaching device FIG. 15A for sequentially supporting the seat sliding in the width direction of the attaching device by a roller and a support plate of the support part.

FIG. 17A is an explanatory view illustrating, in the cover attaching method, a step of pressing the seat from the rear surface of the pad by the compressing mechanisms.

FIG. 17B is an explanatory cross-sectional view illustrating a state of the seat in FIG. 17A and a state of the leading roller and the following roller of the pressing mechanism that are in contact with a part of the cover covering the sitting surface.

FIG. 18A is an explanatory view illustrating, in the cover attaching method, a step of holding the cover while pulling the cover along the sitting surface and the side surface of the pad by the leading roller and the following roller of the pressing mechanism moving from the sitting surface to the side surface of the pad via the ridge portion.

FIG. 18B is an explanatory cross-sectional view illustrating a state of the seat in FIG. 18A and a movement of each of the leading roller and the following roller of the pressing mechanism.

FIG. 19A is an explanatory view illustrating, in the cover attaching method, a step of engaging the end of the cover with the rear surface of the pad by a robot arm.

FIG. 19B is an explanatory schematic cross-sectional view illustrating an operation of engaging an engaging member at the end of the cover in FIG. 19A with an engaged section in the rear surface of the pad.

FIG. 20 is an explanatory schematic cross-sectional view illustrating a modification of the seat cover attaching device in the present invention, the modification including a pressing mechanism additionally having a band-shaped member wound around a leading roller and a following roller.

FIG. 21 is an explanatory view illustrating another modification of the seat cover attaching device in the present invention, the modification including an example concave roller having a concaved center portion and serving as a leading roller and a following roller.

### DESCRIPTION OF EMBODIMENTS

Hereinafter, a seat cover attaching device according to embodiments of the present invention will be described in detail with reference to the accompanying drawings.

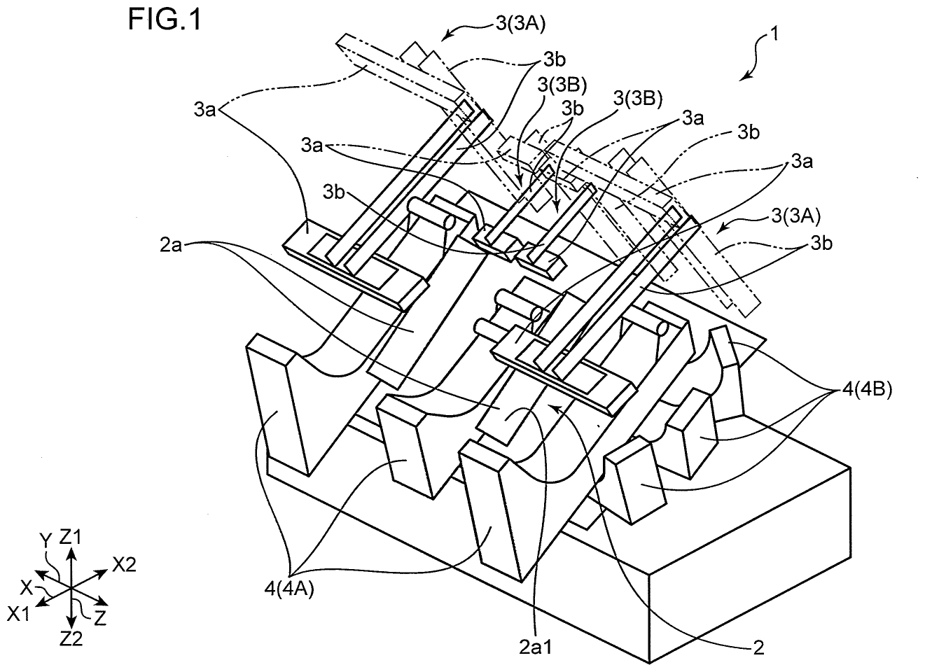

As illustrated in FIG. 1 to FIG. 6, a seat cover attaching device 1 (hereinafter, referred to as an “attaching device 1”) is configured to attach a cover SK, i.e., a trim, of a seat S to a surface of a pad SP while pulling the cover in an upside-down state of the seat S. In an embodiment, description will be made with reference to a front-rear direction X, a width direction Y, and an up-down direction Z of the attaching device 1 in the drawings.

### Description of the Seat S

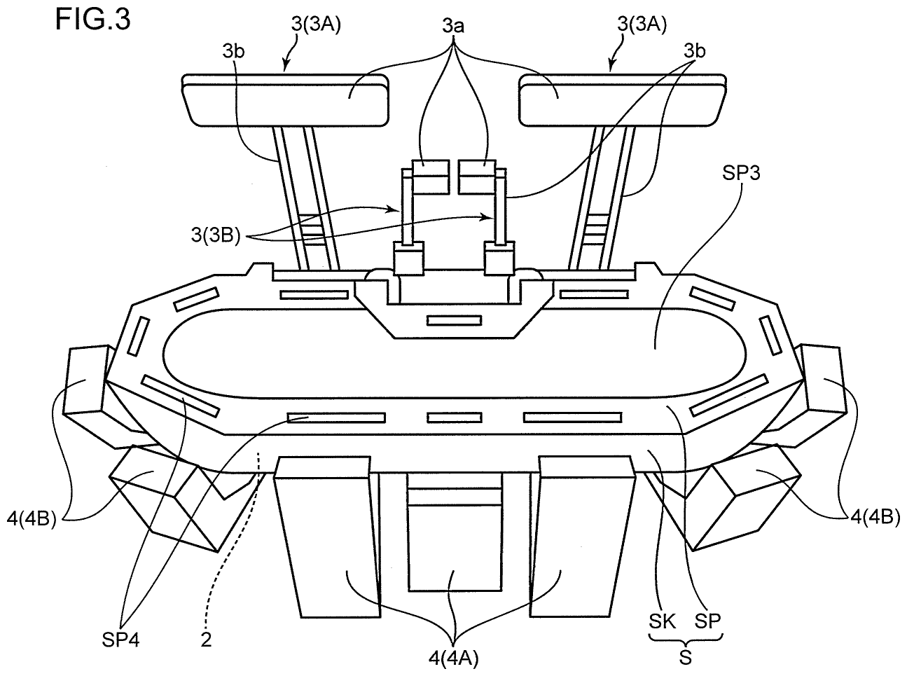

The seat S targeted for attachment of the cover SK by the attaching device 1 in the embodiment is illustrated in an upside-down state in FIG. 3 and FIG. 5 to FIG. 7. The seat S is a seat for a vehicle or other seat, and includes a pad SP made of urethane or other elastic material, and a cover SK covering a surface of the pad SP.

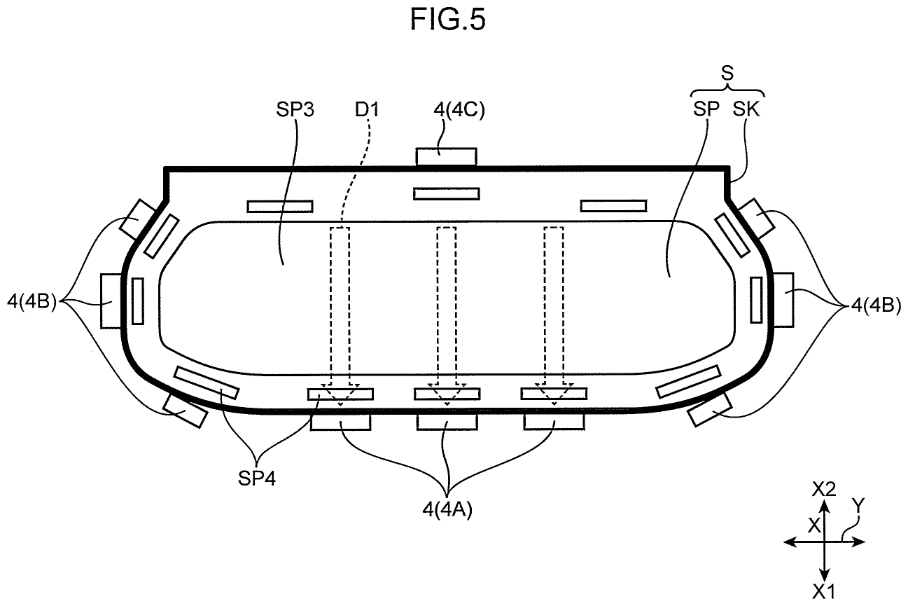

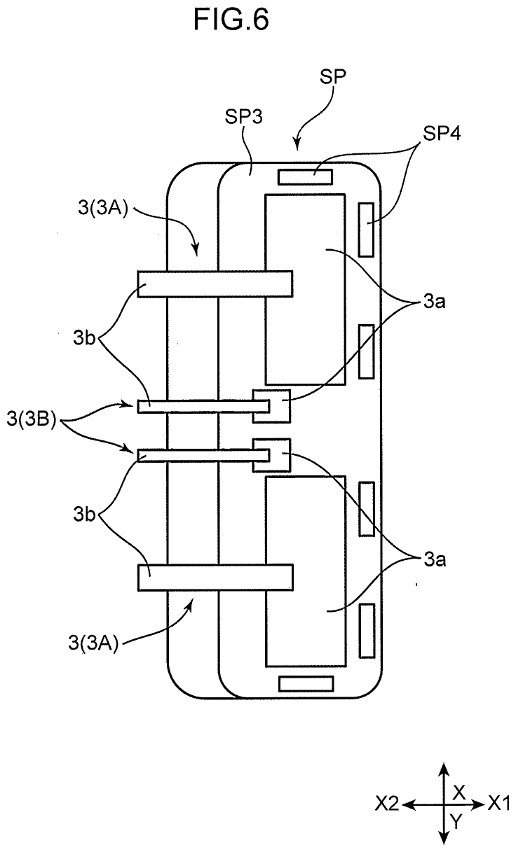

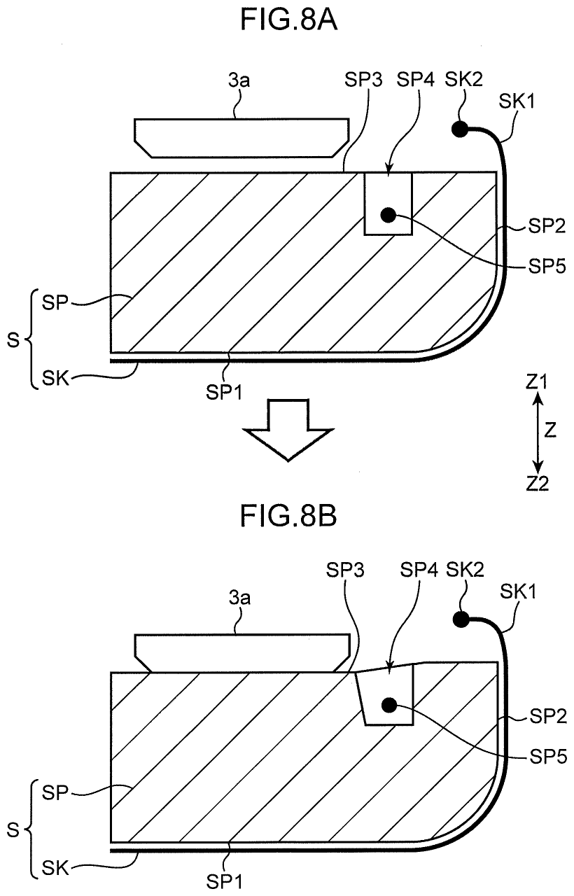

The pad SP is a thick member or a flat block-shaped member extending in the width direction Y for allowing a plurality of occupants to sit thereon side by side in the width direction Y. The pad SP has a sitting surface SP1 horizontally expanding for allowing the occupants to sit thereon, a side surface SP2 continuing to a periphery of the sitting surface SP1 and extending in the up-down direction Z, and a rear surface SP3 that is opposite to the sitting surface SP1. The rear surface SP3 has a periphery formed with a plurality of opening parts SP4 each having a groove shape for holding an end of the cover SK (see FIG. 5 to FIG. 6). Each of the opening parts SP4 has therein an engaged section SP5, such as a metal wire, to be engaged with an engaging section SK2, such as a hook, provided at an end SK1 of the cover SK as illustrated in FIG. 8A to FIG. 8B.

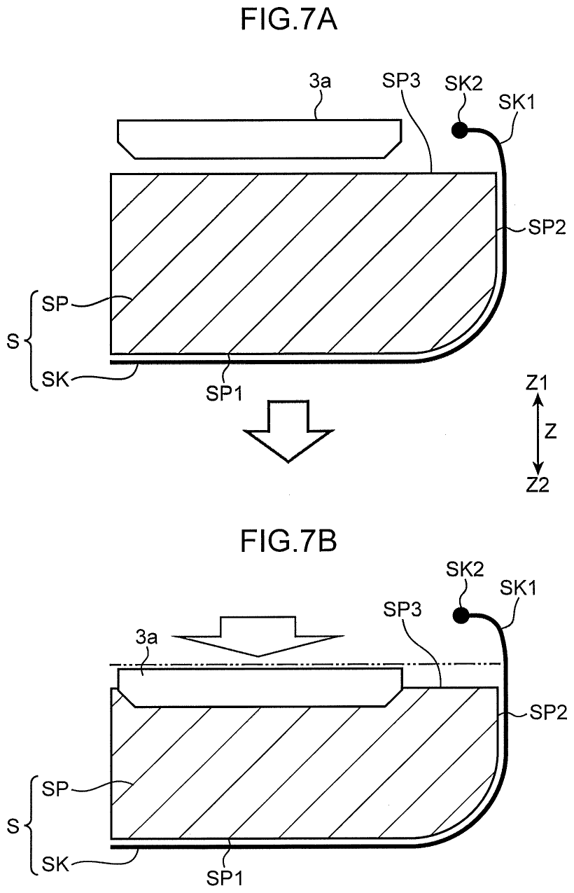

The cover SK is a sheet-like member or a bag-like member made of leather, synthetic resin, or other material having stretchability and flexibility, and has such a shape and an extent as to fully cover the sitting surface SP1 and the side surface SP2 of the pad SP. The end SK1 of the cover SK (an end of a periphery of the cover) is provided with a plurality of the engaging sections SK2 (see FIG. 7 to FIG. 8), such as hooks, as described above.

### Detailed Configuration of the Attaching Device 1

Specifically, as illustrated in FIG. 1 to FIG. 6, the attaching device 1 includes a support part 2 that supports the pad SP and the cover SK of the seat S to be placed in a stacked manner thereon, a plurality of compressing mechanisms 3 that compresses the pad SP downward Z2, and a plurality of pressing mechanism 4 that presses the cover SK onto the surface of the pad SP. The compressing mechanisms 3 are located upward Z1 with respect to the support part 2. The pressing mechanisms 4 are arranged apart from one another in such a manner as to protrude outward from the support part 2. The support part 2, the compressing mechanisms 3, and the pressing mechanisms 4 are attached to a common frame to integrally constitute the attaching device 1.

As illustrated in FIG. 1 to FIG. 2 and FIG. 4A to FIG. 4C, the support part 2 has a plurality of support plates 2a and at least one roller 2b (two rollers in the embodiment) on each of the support plates 2a. The support plates 2a are metal plate members made of stainless or other metal and extending in the front-rear direction X, and are arranged apart from each other in the width direction Y.

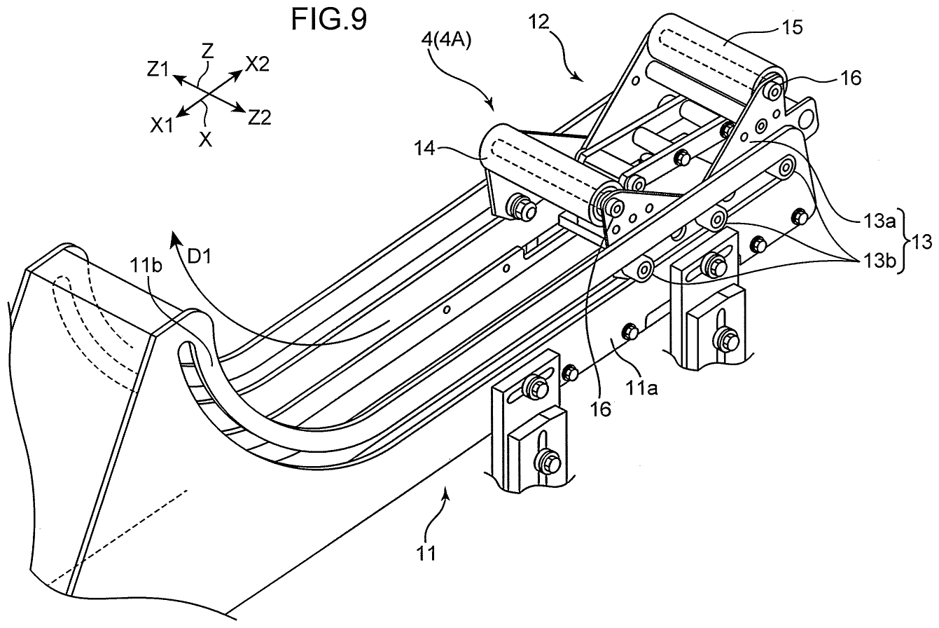

Each support plate 2a and a support surface 2a1 forming an upper surface of the support plate slope downward as advancing toward a downstream end of the support part 2 in a moving direction D1 of a leading roller 14 (see FIG. 5 and FIG. 9) to be described later, that is, slope downward as advancing toward an end of the support part that is located frontward X1.

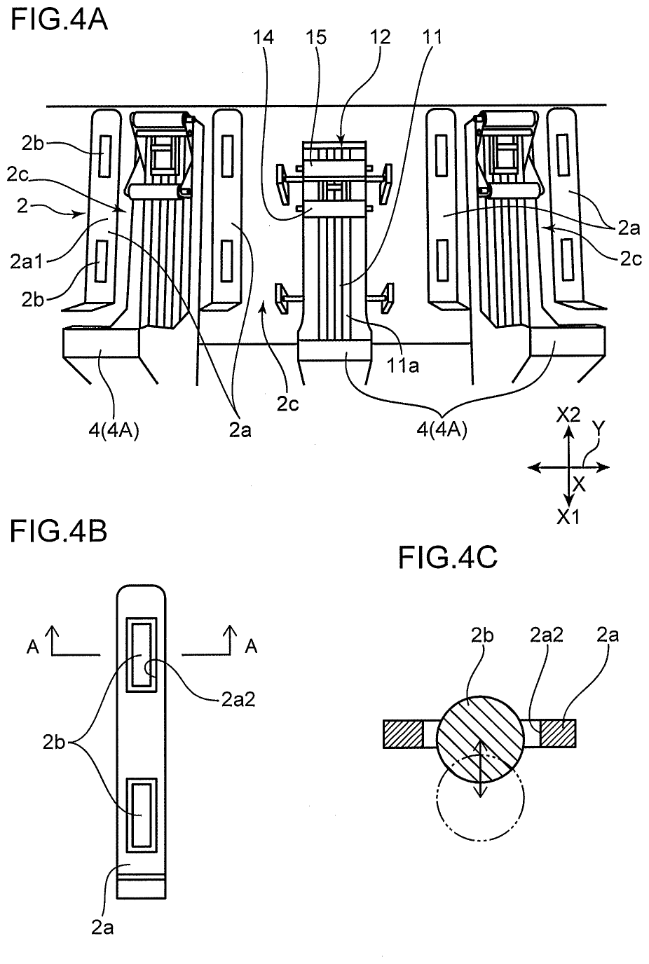

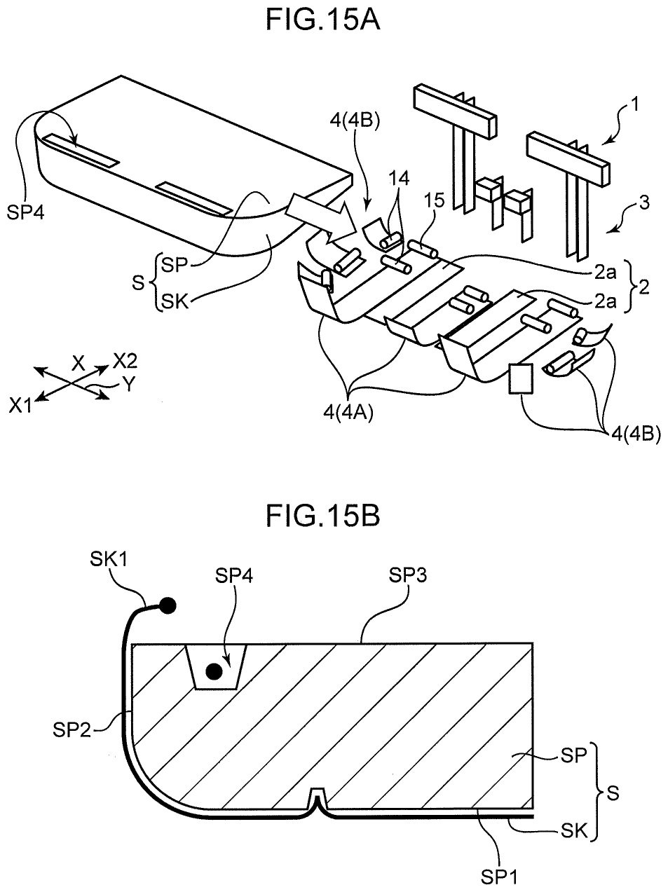

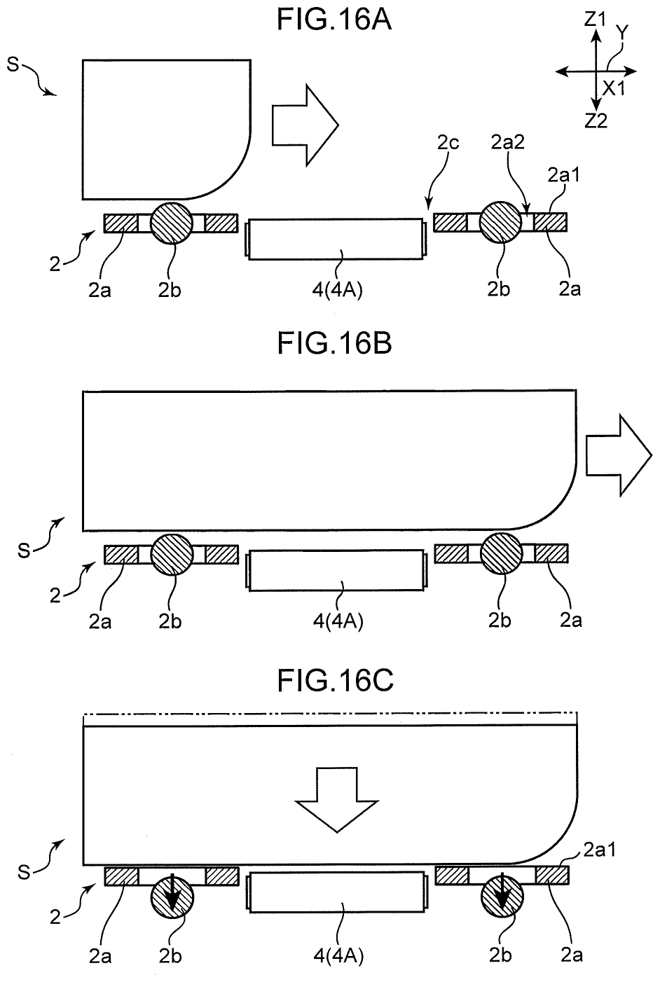

As illustrated in FIG. 4B to FIG. 4C, the roller 2b is a columnar member extending in the front-rear direction X and arranged in a through hole 2a2 formed in the support plate 2a. The roller 2b is rotatable about a rotary shaft (not shown) extending in the front-rear direction X and is assembled to freely come in the through hole 2a2 and out of the through hole above the support plate 2a. The roller 2b or the rotary shaft of the roller 2b is always urged upward by an unillustrated spring. As illustrated in FIG. 15 to FIG. 16, the support part 2 having the roller 2b makes the roller 2b guide and horizontally convey the seat S in the width direction Y of the attaching device 1 to place the seat S on the support part 2. Consequently, the seat S can be easily placed on the support part 2.

The support surface 2a1 of the support plate 2a of the support part 2 receives the seat S (specifically, the pad SP and the cover SK) in an upside-down state, that is, in a state where the sitting surface SP1 of the pad SP faces downward Z2 and the cover SK lies below or downward Z2 with respect to the pad SP (see FIG. 3, FIG. 7 to FIG. 8, and FIG. 16).

The support plates 2a of the support part 2 are arranged apart from each other in the width direction Y. Therefore, a space 2c is defined between two adjacent support plates 2a and spaces 2c are defined respectively on the opposite sides of the two support plates 2a in a pair in the width direction Y. the spaces 2c allow the leading roller 14 and a following roller 15 to move along the sitting surface SP1 of the pad SP (see FIG. 4A and FIG. 16A).

Each of the compressing mechanisms 3 is configured to compress the pad SP on the support part 2 downward Z2 from the rear surface SP3 that is opposite to the sitting surface SP1. Specifically, as illustrated in FIG. 1 to FIG. 3 and FIG. 6, the compressing mechanism 3 includes a compressing tool 3a, an arm 3b which is swingable in the front-rear direction X and has a distal end to which the compressing tool 3a is fixedly attached, and a drive part (not shown) for swinging the arm 3b in the up-down direction Z about a rotary shaft (not shown) extending in the width direction Y. The arm 3b having received a drive force from the drive part swings frontward X1 to enable the compressing tool 3a to press the rear surface SP3 of the pad SP downward Z2.

The compressing mechanisms 3 can broadly include side compressing mechanisms 3A at the opposite positions in the width direction Y and a center compressing mechanism 3B at the center in the width direction Y. Each of the side compressing mechanisms 3A includes a compressing tool 3a having a large flat plate shape at a position suitable for pressing a portion of the rear surface SP3 of the pad SP that is closer to the associated opening part SP4 for holding the cover SK (see FIG. 6 and FIG. 8). The center compressing mechanism 3B includes a compressing tool 3a having a block or flat plate shape to press the rear surface SP3 of the pad SP with a smaller area than an area of the compressing tool 3a of the side compressing mechanism 3A, and can press a center potion of the rear surface SP3 of the pad SP in the width direction Y.

The compressing tool 3a and the arm 3b can retract upward Z1 highly enough to avoid contact with the seat S in setting of the seat S on the attaching device 1. By contrast, the compressing tool 3a can press the rear surface SP3 of the pad SP to compress the pad SP downward Z2 when located downward Z2.

As illustrated in FIG. 7A to FIG. 7B, the compressing tool 3a is pushed onto the rear surface SP3 of the pad SP to compress the pad SP downward Z2, resulting in increasing an upward extension amount of the end SK1 of the cover SK, that is, increasing an amount of the end extending upward Z1 from the side surface SP2 of the pad SP. This allows the engaging section SK2, such as a hook, provided at the end SK1 to easily engage the engaged section SP5 in the opening part SP4 in the rear surface SP3 of the pad SP5 (FIG. 8A to FIG. 8B) without excessively pulling the cover SK upward by the rollers 14, 15 to be described later.

Each of the pressing mechanisms 4 illustrated in FIG. 1 to FIG. 5 is configured to press the cover SK onto the surface of the pad SP. The pressing mechanisms 4 broadly include a center pressing mechanism 4A located around the center of the support part 2 in the width direction Y, side pressing mechanisms 4B located on both sides of the support part 2 in the width direction Y, and a rear pressing mechanism 4C (see FIG. 5) located rearward X2 with respect to the support part 2. The pressing mechanisms 4 are arranged respectively to be at locations of the opening parts SP4 of the pad SP of the seat S set on the support part 2, that is, arranged respectively to be at locations closer to the engaging sections SK2 or hooks of the cover SK.

The center pressing mechanism 4A has a rail 11 and a movable part 12 as illustrated in FIG. 9.

The rail 11 has a front-rear directional portion 11a extending in the front-rear direction X in the space 2c (see FIG. 4A) between the support plates 2a of the support part 2, and an up-down directional portion 11b extending upward Z1 continuously from the front-rear directional portion 11a in adjacent to the end of the support part 2 that is located frontward X1. The up-down directional portion 11b is smoothly continuous from the front-rear directional portion 11a in an arc.

The movable part 12 is movably guided by the rail 11. Specifically, the movable part 12 has a carriage 13 and a plurality of rollers including the leading roller 14 and the following roller 15 rotatably attached to the carriage 13. The leading roller 14 and the following roller 15 move together with the movable part 12 and serve to pull the cover SK while pressing the cover. Specifically, the leading roller 14 and the following roller 15 roll over an outer surface of the cover SK while pressing the cover SK onto the surface of the pad SP to thereby pull, i.e., stretch, the cover SK. The carriage 13 has a frame 13a and a plurality of rollers 13b rotatably provided to the frame 13a to be guided by the rail 11.

The movable part 12 is guided by the rail 11 to be movable in the front-rear direction X along the front-rear directional portion 11a in the space 2c between the support plates 2a of the support part 2 and movable in the up-down direction Z along the up-down directional portion 11b being in adjacent to the end of the support part 2 frontward X1. The movable part 12 is movable along the rail 11 by an unillustrated drive part. This configuration enables each of the leading roller 14 and the following roller 15 to move from a predetermined movement start position to a predetermined stop position and stay in a stop state at the stop position.

The leading roller 14 and the following roller 15 are rotatably attached to the frame 13a of the carriage 13 via a rotary shaft 16. The following roller 15 is located apart from and behind the leading roller 14 in a moving direction D1 of the leading roller 14, and is movable to follow the leading roller 14 while keeping a predetermined distance therefrom.

Each of the leading roller 14 and the following roller 15 is provided with an unillustrated reverse rotation prevention mechanism, such as a ratchet. The reverse rotation prevention mechanisms respectively prevent the leading roller 14 and the following roller 15 from rotating in a rotation direction corresponding to a direction in which the pulled cover SK returns to its original position. In this regard, the reverse rotation prevention mechanisms keep the rollers 14, 15 from rotating against a counterforce of the cover SK to return to the original position, which will be described later, when the rollers 14, 15 having pulled up the cover SK stop at their respective predetermined positions. Consequently, the returning of the cover SK can be prevented.

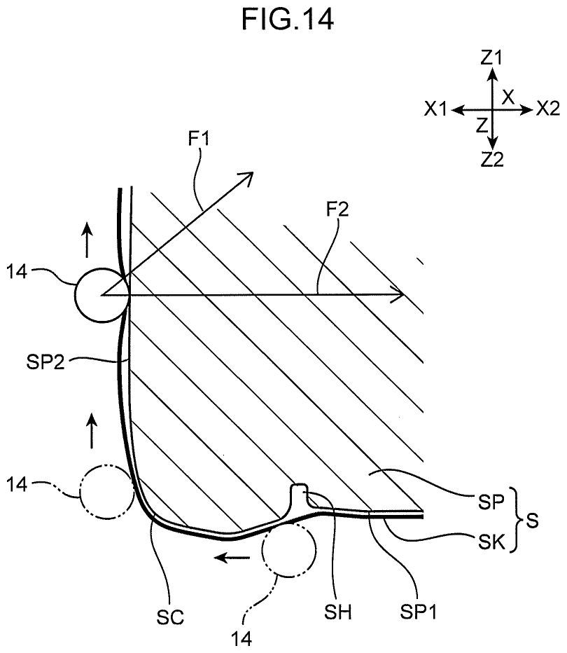

The center pressing mechanism 4A further includes an elastic member (not shown) that gives each of the leading roller 14 and the following roller 15 a pressing force to press the cover SK. For instance, as illustrated in FIG. 14, the elastic member gives the leading roller 14 a pressing force F1 of slightly tilting the leading roller in the moving direction thereof in the movement of the leading roller 14 along the side surface SP2 of the pad SP to press the cover SK onto the pad SP with a resultant force F2 (a force of pressing the outer surface of the cover SK in a normal direction) combining the pressing force F1 and the counterforce from the pad SP.

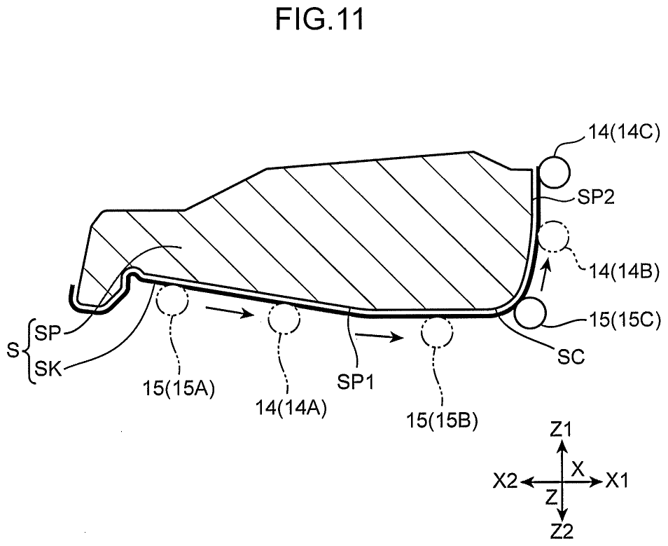

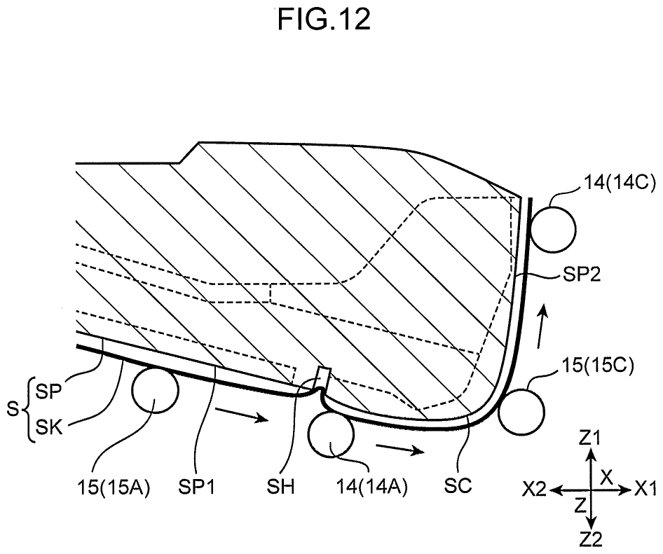

The movable part 12 illustrated in FIG. 9 moves along the rail 11 to enable the leading roller 14 and the following roller 15, as illustrated in FIG. 11 to FIG. 12, to start to move from their respective predetermined movement start positions 14A and 15A (shown in FIG. 11 to FIG. 12) downward Z2 with respect to the sitting surface SP1 of the pad SP of the seat S on the support part 2, pass through a ridge portion SC of the pad SP (see positions 14B and 15B shown in FIG. 11), and finally reach their respective predetermined stop positions 14C and 15C (shown in FIG. 11 to FIG. 12) on the side surface SP2 of the pad SP.

Here, as illustrated in FIG. 11 to FIG. 12, the following roller 15 preferably follows the leading roller 14 at such a distance that the following roller 15 is near to the ridge portion SC (specifically, at the position 15C around a lower end of the side surface SP2) when the leading roller 14 reaches the predetermined stop position 14C and 15C (shown in FIG. 11 to FIG. 12) on the side surface SP2.

Further, as illustrated in FIG. 12, the pad SP of the seat S in the embodiment has, in the sitting surface SP1, a pull-in groove section SH for holding a part of the cover SK. In this case, the movement start position 14A (shown in FIG. 12) of the leading roller 14 is preferably between the pull-in groove section SH in the sitting surface SP1 and the ridge portion SC and near to the pull-in groove section SH. Specifically, the leading roller 14 is arranged closest to the pull-in groove section SH while avoiding coming into contact with the pull-in groove section.

The side pressing mechanisms 4B illustrated in FIG. 1 to FIG. 3 and FIG. 5 are located on both sides of the support part 2 in the width direction Y. Each of the side pressing mechanisms 4B basically includes a rail 11 and a movable part 12 which moves along the rail 11 in the same manner as the center pressing mechanism 4A, and further may have a leading roller 14 and a following roller 15 both, or have only the leading roller 14. The rail 11 of the side pressing mechanism 4B may have such a length as not to come into contact with the associated support plate 2a of the support part 2 at a specific position. Similarly, the rear pressing mechanism 4C shown in FIG. 5 is only required to include a rail 11 and a movable part 12 which moves along the rail 11 in the same manner as the side pressing mechanism B, and may have a leading roller 14 and a following roller 15 both, or have only the leading roller 14. The attaching device 1 including the support part 2 having the support surfaces 2a1 each sloping frontward X1 with respect to the attaching device 1 has no possibility of receiving a large load exerting rearward X2 from the seat S. In this respect, the rear pressing mechanism 4C can acquire an enough tension amount of the cover SK solely with the leading roller 14.

### Description of a Seat Cover Attaching Method

Next, a seat cover attaching method in use of the attaching device 1 will be described with reference to FIG. 15 to FIG. 19.

First, as illustrated in FIG. 15A to FIG. 15B, the seat S is set onto the attaching device 1 while being conveyed in the width direction Y of the attaching device 1 in an upside-down state of the seat S, that is, in a state where the sitting surface SP1 of the pad SP faces downward Z2 and the cover SK lies below or downward Z2 with respect to the pad SP. At the setting, the rollers 14, 15 of each of the pressing mechanisms 4 as illustrated in FIG. 15A are in standby at their respective movement start positions (near to a corresponding end of the support plate 2a of the support part 2 that is located rearward X2 or in adjacent to the support plate 2a).

As illustrated in FIG. 16A to 16B, the roller 2b at the support part 2 protrudes upward Z1 and above the support surface 2a1 through the through hole 2a2 in the support plate 2a by an unillustrated spring in a horizontal movement of the seat S in the width direction Y of the attaching device 1. This configuration allows the roller 2b to receive the seat S, and easily guide and move the seat S in the width direction to a predetermined setting position so that the seat S expands over all the support plates 2a.

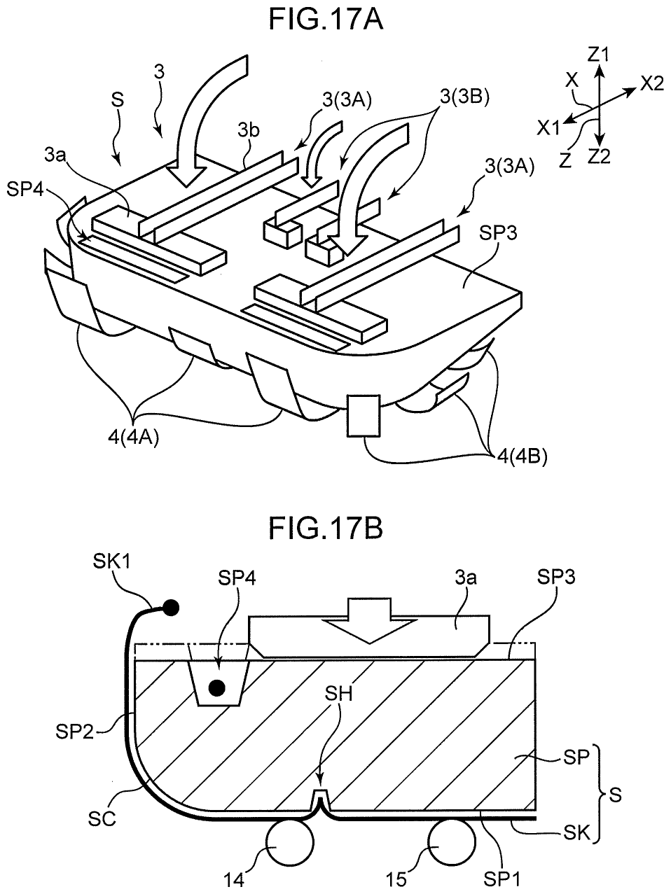

Thereafter, as illustrated in FIG. 17A to FIG. 17B, each compressing mechanism 3 compresses the seat S downward Z2. Specifically, the compressing mechanism 3 makes the compressing tool 3a and the arm 3b slew frontward X1 and downward Z2, and makes the compressing tool 3a push the rear surface SP3 of the pad SP downward Z2. At the pushing, as illustrated in FIG. 16C, the roller 2b of the support part 2 is also pushed downward together with the seat S, so that the seat S comes into contact with the support surface 2a1 of the support plate 2a of the support part 2. At this time, as illustrated in FIG. 17B, the seat S comes into contact with the leading roller 14 and the following roller 15 of the center pressing mechanism 4A.

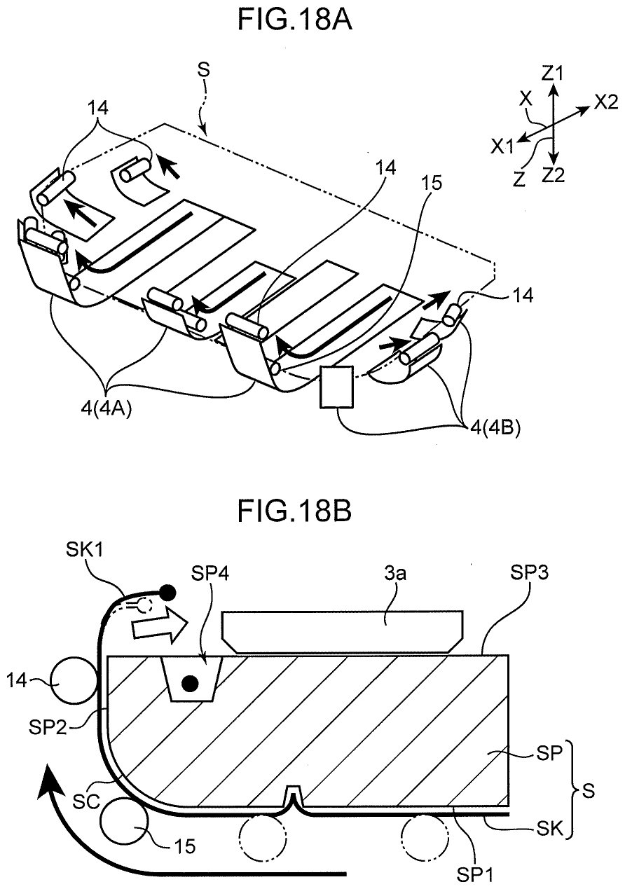

Subsequently, as illustrated in FIG. 18A to FIG. 18B, the rollers of the pressing mechanisms 4 (specifically, the leading roller 14 and the following roller 15 of the center pressing mechanism 4A and the roller 14 of each of the side pressing mechanism 4B) hold the cover SK while pulling the cover along the sitting surface SP1 and the side surface SP2 of the pad SP in a continuous movement from the sitting surface SP1 to the side surface SP2 of the pad SP.

In the center pressing mechanism 4A, the following roller 15 rolling and following the leading roller 14 presses the cover SK onto the sitting surface SP1 to keep the pressing force to the cover SK in the movement of the leading roller 14 from the sitting surface SP1 to the side surface SP2 via the ridge portion SC, resulting in preventing the cover SK from returning.

As illustrated in FIG. 18A to FIG. 18B, when the leading roller 14 and the following roller 15 reach their predetermined positions on the side surface SP2, an unillustrated drive part of the pressing mechanism 4 is stopped so that the rollers stop moving in a state of keeping the pressing force onto the cover SK. The compressing tool 3a keeps compressing the pad SP downward Z2, and hence, an upward extension amount of the end SK1 of the cover SK from the side surface SP2 increases. This facilitates an access to each opening part SP4 in the rear surface SP3 of the pad SP.

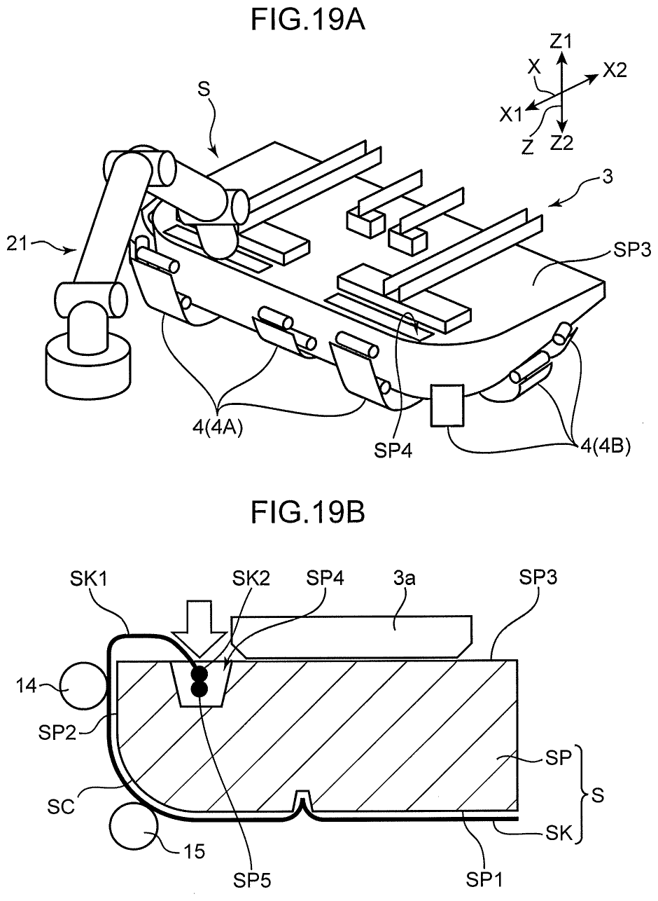

In this state, as illustrated in FIG. 19A to FIG. 19B, an end shifting mechanism 21, such as a robot hand, or a hand of a person catches the end SK1 of the cover SK to engage the engaging section SK2, such as a hook, at the end SK1 with the engaged section SP5, such as a metal wire, in the opening part SP4 in the pad SP. This configuration achieves facilitated fixation of the end SK 1 of the cover SK with a hand of a person or a machine like the robot hand depending on a situation.

### Features of the Embodiment

(1) The attaching device 1 in the embodiment includes, as illustrated in FIG. 1 to FIG. 6 and described above, the support part 2 that supports the pad SP and the cover SK of the seat S to be placed thereon in a stacked manner while the seat S is in an upside-down state, the plurality of compressing mechanisms 3 that compresses the pad SP downward Z2, and the plurality of pressing mechanisms 4 that presses the cover SK onto the surface of the pad SP.

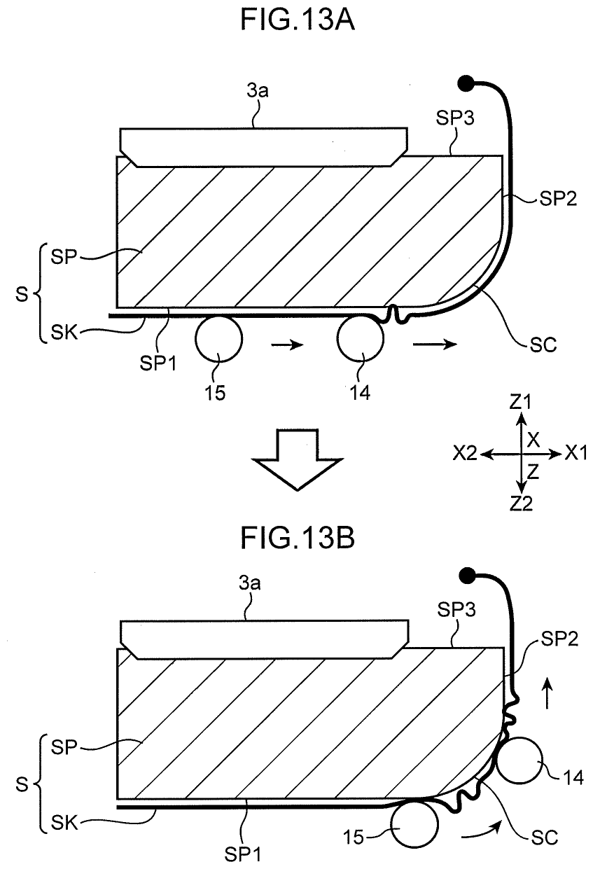

As illustrated in FIG. 9 and FIG. 11 to FIG. 14, the center pressing mechanism 4A among the pressing mechanisms 4 has a plurality of rollers including the leading roller 14 and the following roller 15 rolling over the outer surface of the cover SK while pressing the cover SK onto the surface of the pad SP to thereby pull the cover SK. The following roller 15 follows the leading roller 14 at a distance behind the leading roller in the moving direction D1 of the leading roller 14. The leading roller 14 and the following roller 15 move from the sitting surface SP1 to the side surface SP2 of the pad SP via the ridge portion SC defined by the sitting surface SP1 and the side surface SP2.

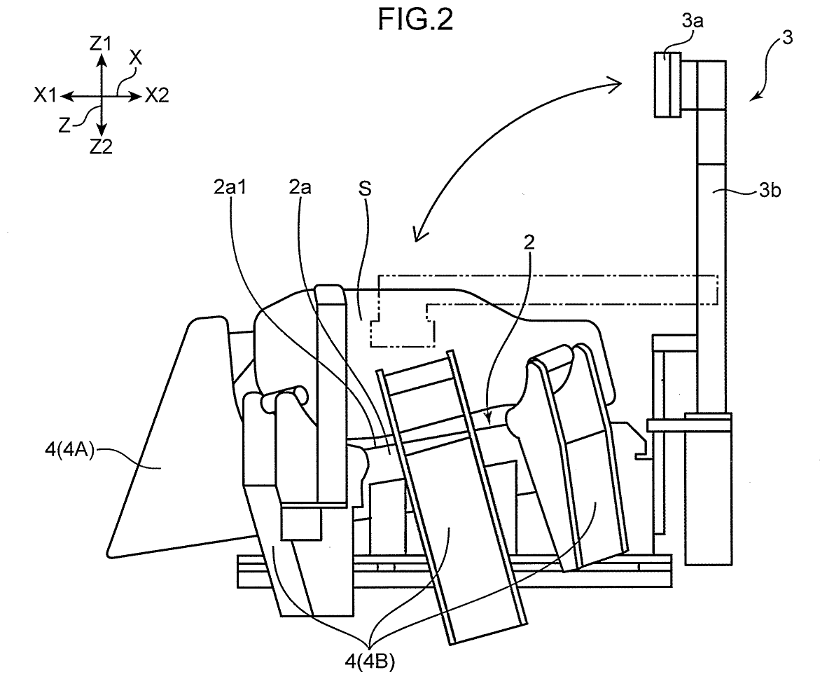

In this configuration, the leading roller 14 and the following roller 15 that follows the leading roller at a predetermined distance hold the cover SK while pulling the cover SK along the sitting surface SP1 and the side surface SP2 of the pad SP in a movement from the sitting surface SP1 to the side surface SP2 of the pad SP via the ridge portion SC defined by the sitting surface SP1 and the side surface SP2. The cover SK covering the sitting surface SP1 has a tendency to return to an original state as the pressing force from the leading roller 14 ceases in the movement of the leading roller 14 from the sitting surface SP1 to the side surface SP2 via the ridge portion SC. In this regard, the following roller 15 that follows the leading roller 14 presses the cover SK covering the sitting surface SP1 to keep the pressing force to the cover SK, resulting in preventing the cover SK from returning.
(2) The attaching device 1 in the embodiment includes the support part 2 that has, as illustrated in FIG. 2 and FIG. 4A, the support surface 2a1 sloping downward as advancing toward the downstream end of the support part 2 in the moving direction D1 (see FIG. 5 and FIG. 9) of the leading roller 14, that is, sloping downward as advancing toward an end of the support part 2 that is located frontward X1.

This configuration supporting the pad SP on the support surface 2a1 sloping downward as advancing toward the downstream end of the support part 2 (that is located frontward X1) in the moving direction D1 facilitates determination of the position of the supported pad SP and achieves suppression of displacement of the pad SP from the support surface 2a1. Specifically, the pad SP on the support surface 2a1 sloping frontward X1 comes into contact with a portion rising in the up-down direction Z around the end of the support part 2 that is located frontward X1, e.g., the up-down directional portion 11b (see FIG. 9) in the rail of the center pressing mechanism 4A. This leads to the facilitated determination of the position of the pad SP.

Moreover, a person or a machine like a robot hand can easily perform the seat cover attaching operation frontward X1 with respect to the support part 2. Hence, the attaching operation is also applicable to a pad SP having a larger size with a smaller movement amount at a reduced load.
(3) In the attaching device 1 in the embodiment, a distance between the leading roller 14 and the following roller 15 is set to such a distance that the following roller 15 is near to the ridge portion SC, specifically, is around the lower end of the side surface SP2, when the leading roller 14 reaches the predetermined stop position on the side surface SP2, as illustrated in FIG. 11 to FIG. 12.

The setting of the distance between the leading roller 14 and the following roller 15 in the aforementioned manner allows the following roller 15 to come near to the ridge portion SC when the leading roller 14 reaches the predetermined stop position (i.e., an upper end of the cover SK) on the side surface SP2 of the pad SP. This achieves ensured prevention of returning of the cover SK around the ridge portion SC.
(4) In the attaching device 1 in the embodiment, as illustrated in FIG. 12, the pad SP has, in the sitting surface SP1, the pull-in groove section SH for holding a part of the cover SK, and the movement start position 14A (FIG. 12) of the leading roller 14 is between the pull-in groove section SH in the sitting surface SP1 and the ridge portion SC and near to the pull-in groove section SH.

This configuration in which the movement start position of the leading roller 14 is between the pull-in groove section SH and the ridge portion SC and near to the pull-in groove section SH enables the leading roller 14 to effectively pull the cover SK in a state where the pull-in groove section SH holds, in the sitting surface SP1 of the pad SP, a part of the cover SK.

In a case where the pull-in groove section SH is provided with a seat heater having wires, the setting of the movement start position of the leading roller 14 in the aforementioned manner can avoid disconnection in the seat heater.
(5) In the attaching device 1 in the embodiment, the pressing mechanism 4 further includes an elastic member (not shown) that gives each of the leading roller 14 and the following roller 15 a pressing force to press the cover SK. This configuration including the elastic member, such as a spring, in a direction of pressing the cover SK keeps a steady pressing force, maintains a stable tension amount of the cover SK, and reduces a damage to the cover SK and the pad SP attributed to an excessive force.
(6) In the attaching device 1 in the embodiment, the pressing mechanism 4 is configured to stop in a state of keeping the pressing force to the cover SK when each of the leading roller 14 and the following roller 15 reaches a predetermined position on the side surface SP2. This configuration in which each of the leading roller 14 and the following roller 15 stops in a state of keeping the pressing force to the cover SK prevents the cover SK having been pulled up from the sitting surface SP1 to the side surface SP2 of the pad SP from returning. The configuration further achieves prevention of a damage to the cover SK, such as a crease or breakage, attributed to a non-uniform tensile force in fixedly attaching the end of the cover SK onto the rear surface SP3 of the pad SP.
(7) The attaching device 1 in the embodiment includes a plurality of pressing mechanisms 4 each including rollers 14, 15 configured to press the cover SK onto the surface of the pad SP while rolling over the outer surface of the cover SK. The configuration makes the rollers 14, 15 roll over the outer surface of the cover SK while pressing the cover SK to thereby attain uniform pressing over the cover SK even along a curvy surface of the pad SP.
(8) The attaching device 1 in the embodiment further includes a plurality of compressing mechanism 3 that compresses the pad SP on the support part 2 downward from the rear surface SP3 of the pad SP that is opposite to the sitting surface SP1. The compressing mechanisms 3 respectively include compressing tools 3a independent from one another. The independent compressing tools 3a compress the pad SP to thereby reduce an amount of pulling the cover SK by the rollers 14, 15 of each pressing mechanism 4. This configuration further prevents the pad SP from coming into an unstable state due to displacement or deformation of the pad SP in fixing the end SK1 of the cover SK to the rear surface SP3 of the pad SP.
(9) Although the arrangement of the compressing tools 3a in the compressing mechanisms 3 is not particularly limited in the present invention, the compressing tool 3a of each of the side compressing mechanisms 3A is preferably arranged, as illustrated in FIG. 6 and FIG. 8A to FIG. 8B, at such a position as to compress a portion of the rear surface SP3 of the pad SP that is near the opening part SP4. In the arrangement of the compressing tool 3a, the compressing tool 3a pushes and compresses the pad SP downward Z2, and the opening part SP4 has a larger width in the rear surface SP3 of the pad SP near the compressing tool 3a. This facilitates the engagement with the engaged section SP5.

In a case where the pad SP does not have uniform elasticity, for example, in a case where the pad SP contains foam beads or other member having different hardness, a boundary between two regions having different hardness in the pad SP has a large deformation difference. In this respect, compressing the areas by the compressing tool 3a individually may lead to separation or breakage of the pad SP, or other failure. To avoid such a failure, the size and the arrangement of the compressing tool 3a are set so that the compressing tool 3a can solely compress the two regions having the different hardness in the pad SP at the same time across the boundary of the two regions. The setting consequently succeeds in avoiding separation or other failure.

### Modifications

(A) Although the embodiment shows an example where the attaching device 1 includes the pressing mechanisms 4 (specifically, the center pressing mechanism 4A) each having a plurality of rollers including the leading roller 14 and the following roller 15 for pressing the cover SK, each of the rollers 14, 15 may be changed depending on a target to be pressed by the rollers to meet the shape of the target.

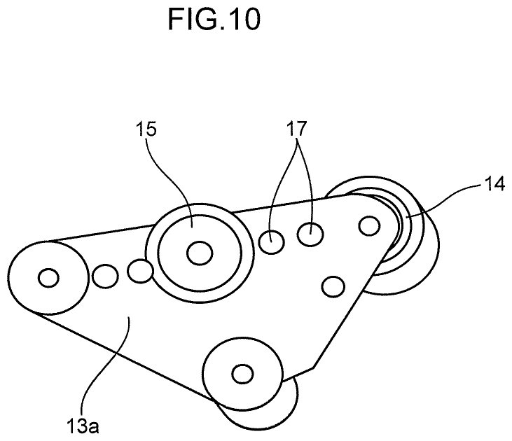

For instance, a modification of the seat cover attaching device in the present invention may include a pressing mechanism 4 having a leading roller 14 and a following roller 15 at a changeable distance therebetween. Specifically, in the modification of the present invention, as illustrated in FIG. 10, the frame 13a of the carriage illustrated in FIG. 9 may have a plurality of attachment holes 17 for a change in an attachment position of the following roller 15. This allows for an appropriate change in a distance between the leading roller 14 and the following roller 15 to meet the shape of the ridge portion SC of the pad SP. In other words, the distance between the rollers 14, 15 can be increased in accordance with a larger curvature radius of the ridge portion SC, and the distance between the rollers 14, 15 can be decreased in accordance with a smaller curvature radius thereof.

(B) In another modification of the present invention, the leading roller 14 has a diameter which is different from a diameter of the following roller 15. Setting of the diameters (roller diameters) of the leading roller 14 and the following roller 15 to be different from each other results in different pressing forces to the cover SK with different contact areas, and thus increases a tension amount of the cover SK. This effectively prevents the cover SK from returning. For instance, a larger outer diameter of the following roller 15 than an outer diameter of the leading roller 14 leads to a greater pressing force from the following roller 15 to the cover SK than a pressing force from the leading roller 14 thereto.

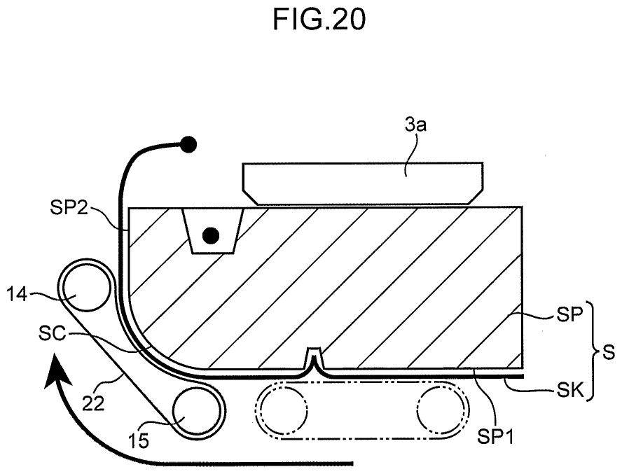

(C) In still another modification of the present invention, as illustrated in FIG. 20, the pressing mechanism 4 may further have a band-shaped member 22, such as a belt, wound around the leading roller 14 and the following roller 15. The band-shaped member 22 connecting the rollers 14, 15 to each other increases an area of the pressing mechanism 4 that comes into contact with the cover SK, and the band-shaped member 22 further continues to apply a steady pressing force to the cover SK in the ridge portion SC of the pad SP. This effectively prevents the cover SK from returning.

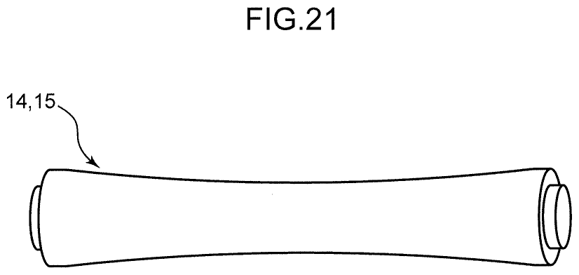

(D) In further another modification of the present invention, as illustrated in FIG. 21, each of the leading roller 14 and the following roller 15 may be a concave roller having a concave in a longitudinal center portion of the roller. The leading roller 14 and the following roller 15 each having the thicker opposite ends and the thinner concaved center portion can exert a force toward the opposite ends in the longitudinal direction of the rollers 14, 15 when the rollers 14, 15 press the cover SK. This attains a further advantageous effect of removing creases of the cover SK.

(E) In still further another modification of the present invention, the pressing mechanism 4 may further include a heating way of heating the leading roller 14 and the following roller 15. Examples of the heating way include a heater and a vapor generator. The combination of pressing the cover SK with the rollers 14, 15 and heating the rollers by the heating way attains a more advantageous effect of removing creases of the cover SK.

### Summary of Embodiment

The embodiment is summarized in the following manner.

A seat cover attaching device in the embodiment is a seat cover attaching device for attaching a cover covering a surface of a pad included in a seat while pulling the cover along a sitting surface of the pad and a side surface continuing to a periphery of the sitting surface. The seat cover attaching device includes: a support part that supports the pad and the cover to be placed thereon in a state where the sitting surface of the pad faces downward and the cover lies below the pad; a compressing mechanism that compresses the pad on the support part downward from a rear surface of the pad that is opposite to the sitting surface; and a pressing mechanism that presses the cover onto the surface of the pad. The pressing mechanism has a plurality of rollers that rolls over an outer surface of the cover while pressing the cover onto the pad to thereby pull the cover. The rollers include a leading roller and a following roller that follows the leading roller at a distance behind the leading roller in a moving direction of the leading roller. The leading roller and the following roller move from the sitting surface of the pad to the side surface via a ridge portion defined by the sitting surface and the side surface.

In this configuration, the leading roller and the following roller that follows the leading roller hold the cover while pulling the cover along the sitting surface and the side surface of the pad in a movement from the sitting surface to the side surface of the cover via the ridge portion defined by the sitting surface and the side surface. The cover covering the sitting surface has a tendency to return to an original state as the pressing force from the leading roller ceases in the movement of the leading roller from the sitting surface to the side surface via the ridge portion. In this regard, the following roller that follows the leading roller presses the cover covering the sitting surface to keep the pressing force to the cover and thus prevents the cover from returning.

In the seat cover attaching device, the support part preferably has a support surface sloping downward as advancing toward a downstream end of the support part in the moving direction.

This configuration supporting the pad on the support surface sloping downward as advancing toward the downstream end of the support part in the moving direction of the leading roller serving as a reference facilitates determination of the position of the supported pad and achieves suppression of displacement of the pad from the support surface.

In the seat cover attaching device, a distance between the leading roller and the following roller is preferably set to such a distance that the following roller is near to the ridge portion when the leading roller reaches a predetermined stop position on the side surface.

The setting of the distance between the leading roller and the following roller in the aforementioned manner allows the following roller to come near to the ridge portion when the leading roller reaches the predetermined stop position on the side surface of the pad. This achieves ensured prevention of returning of the cover around the ridge portion.

In the seat cover attaching device, the pad preferably has, in the sitting surface, a pull-in groove section for holding a part of the cover, and a movement start position of the leading roller is preferably between the pull-in groove section in the sitting surface and the ridge portion and near to the pull-in groove section.

This configuration in which the movement start position of the leading roller is set between the pull-in groove section and the ridge portion and near to the pull-in groove section enables the leading roller to effectively pull the cover in a state where the pull-in groove section holds, in the sitting surface of the pad, a part of the cover.

In the seat cover attaching device, the pressing mechanism preferably further includes an elastic member that gives each of the leading roller and the following roller a pressing force to press the cover.

This configuration including the elastic member, such as a spring, in a direction of pressing the cover keeps a steady pressing force, maintains a stable tension amount of the cover, and reduces a damage to the cover and the pad attributed to an excessive force.

In the seat cover attaching device, the pressing mechanism is preferably configured to change the distance between the leading roller and the following roller.

This configuration allows for an appropriate change in a distance between the leading roller and the following roller to meet the shape of the ridge portion of the pad.

In the seat cover attaching device, the leading roller preferably has a diameter which is different from a diameter of the following roller.

In this configuration, the setting of the diameters of the leading roller and the following roller to be different from each other results in different pressing forces to the cover in different contact areas, and thus increases a tension amount of the cover. This effectively prevents the cover from returning.

In the seat cover attaching device, the pressing mechanism is preferably configured to stop in a state of keeping a pressing force to the cover when each of the leading roller and the following roller reaches a predetermined position on the side surface.

This configuration in which each of the leading roller and the following roller stops in a state of keeping the pressing force to the cover prevents the cover having been pulled up from the sitting surface to the side surface of the pad from returning. The configuration further achieves prevention of a damage to the cover, such as a crease or breakage, attributed to a non-uniform tensile force in fixedly attaching the end of the cover onto the rear surface of the pad.

Conclusively, the seat cover attaching device in the embodiment attains a reduction in a burden in an operation of attaching a cover and achieves prevention of returning of the cover having been pulled and attached.

1. A seat cover attaching device for attaching a cover covering a surface of a pad included in a seat while pulling the cover along a sitting surface of the pad and a side surface continuing to a periphery of the sitting surface, the seat cover attaching device comprising:
a support part that supports the pad and the cover to be placed thereon in a state where the sitting surface of the pad faces downward and the cover lies below the pad;
a compressing mechanism that compresses the pad on the support part downward from a rear surface of the pad that is opposite to the sitting surface; and
a pressing mechanism that presses the cover onto the surface of the pad, wherein
the pressing mechanism has a plurality of rollers that roll over an outer surface of the cover while pressing the cover onto the pad to thereby pull the cover,
the rollers include a leading roller and a following roller that follows the leading roller at a distance behind the leading roller in a moving direction of the leading roller, and
the leading roller and the following roller move from the sitting surface to the side surface of the pad via a ridge portion defined by the sitting surface and the side surface.

2. The seat cover attaching device according to claim 1, wherein the support part has a support surface sloping downward as advancing toward a downstream end of the support part in the moving direction.

3. The seat cover attaching device according to claim 1, wherein a distance between the leading roller and the following roller is set to such a distance that the following roller is near to the ridge portion when the leading roller reaches a predetermined stop position on the side surface.

4. The seat cover attaching device according to claim 1, wherein the pad has, in the sitting surface, a pull-in groove section for holding a part of the cover, and
a movement start position of the leading roller is set between the pull-in groove section in the sitting surface and the ridge portion and near to the pull-in groove section.

5. The seat cover attaching device according to claim 1, wherein the pressing mechanism further includes an elastic member that gives each of the leading roller and the following roller a pressing force to press the cover.

6. The seat cover attaching device according to claim 1, wherein the pressing mechanism is configured to change the distance between the leading roller and the following roller.

7. The seat cover attaching device according to claim 1, wherein the leading roller has a diameter which is different from a diameter of the following roller.

8. The seat cover attaching device according to claim 1, wherein the pressing mechanism is configured to stop in a state of keeping a pressing force to the cover when each of the leading roller and the following roller reaches a predetermined position on the side surface.
